(19) United States
(12) Patent Application Publication
(10) Pub. No.: US 2003/0041333 A1
(43) Pub. Date: Feb. 27, 2003

(54) System and method for automatically answering and recording video calls

(76) Inventors: Paul G. Allen, Mercer Island, WA (US); Michael E. Sears, Bellevue, WA (US); John M. Kellum, Seattle, WA (US)

Correspondence Address: DIGEO, INC C/O STOEL RIVES LLP, 201 SOUTH MAIN STREET, SUITE 1100, ONE UTAH CENTER, SALT LAKE CITY, UT, 84111, US

(21) Appl. No.: 09/940,181

(22) Filed: Aug. 27, 2001

(51) Int. Cl. H04N 7/173

(52) U.S. Cl. 725/106; 725/122

(57) ABSTRACT

A request to establish video communication between a caller and a user of an interactive television system is detected. The caller is identified using information contained within the request. The user is prompted to accept or reject the request. In response to the user rejecting the request or not accepting the request within an established time interval, a pre-recorded video greeting is sent to the caller. Thereafter, a video message is recorded including a video signal received from the caller. While the video message is being recorded, the user may interrupt the recording to establish two-way video communication with the caller.

### BACKGROUND

1. Field of the Invention

The present invention relates generally to the field of interactive television systems. More specifically, the present invention relates to a system and method for automatically answering and recording video calls.

2. Description of Related Background Art

Current systems and devices for answering and recording video calls (also known as “video answering machines”) have a number of limitations. For example, the system disclosed in U.S. Pat. No. 5,896,165, entitled “Method and System for a Video Answering Machine”, may be useful where no one is available to answer a call, but it is a nuisance where a user may wish to answer some calls personally and record others depending on the identity of the caller.

For example, a conventional video answering machine does not identify the caller when an incoming video call is detected. Moreover, a conventional video answering machine does not allow a user to watch a video message being recorded. As video “telemarketing” becomes more prevalent, users will be subjected to numerous intrusive and undesirable video calls as a result of these conventional systems.

In addition, once a video answering machine has started to record a video call, a user may not conventionally interrupt the recording to speak with the caller. Consequently, the user must typically wait until after the video message is recorded before he or she may identity, and communicate with, the caller.

Even if the user could interrupt the recording of a video message to answer a video call, he or she will often be forced to miss all or part of a television program or the like while communicating with the caller. Thus, unless the user is prepared to immediately record the television program before answering the call, the user will inevitably miss at least a portion of the program.

Accordingly, what is needed is a system and method for automatically answering and recording video calls in which the caller is identified when an incoming call is detected. What is also needed is a system and method for automatically answering and recording video calls in which a user may interrupt the recording of a video message to answer a call. What is also needed is a system and method for automatically answering and recording video calls in which a television program or other broadcast entertainment program is automatically buffered to allow a user to subsequently view the program in its entirety.

### BRIEF DESCRIPTION OF THE DRAWINGS

Non-exhaustive embodiments of the invention are described with reference to the figures, in which:

FIG. 1 is a block diagram of a communication system;

FIG. 2 is an illustration of an interactive television system;

FIG. 3 is a block diagram of physical components of a set top box (STB);

FIG. 4 is a dataflow diagram according to a first embodiment of the invention;

FIG. 5 is a dataflow diagram according to a second embodiment of the invention;

FIG. 6 is a dataflow diagram according to a third embodiment of the invention;

FIG. 7 is a dataflow diagram according to a fourth embodiment of the invention;

FIG. 8 is a dataflow diagram according to a fifth embodiment of the invention;

FIG. 9 is a block diagram of logical components of a system for automatically answering and recording video calls;

FIG. 10 is a dataflow diagram according to a sixth embodiment of the invention; and

FIG. 11 is a flowchart of a method for automatically answering and recording video calls.

### DETAILED DESCRIPTION OF THE PREFERRED EMBODIMENTS

The present invention provides a system and method for automatically answering and recording video calls that eliminates or substantially reduces all of the above-identified problems and disadvantages.

In one implementation, an incoming request to establish video communication between a caller and a user of an interactive television (ITV) system is detected. The request may be sent by another ITV system, a dedicated videophone, a personal computer, or another similar device. The request may be embodied in any suitable format according to the devices and/or software being used.

In one embodiment, the ITV system identifies the caller from information contained within the request. The request may contain, for instance, a caller's name, a network address of the caller's ITV system, an image of the caller, a live video signal depicting the caller, or the like.

The ITV system then notifies the user of the request and the identity of the caller. For example, the ITV system may display a text identification of the caller, a live video signal of the caller, an image of the caller, and so forth. Based on the identity of the caller, the user may accept or reject the video communication request.

If the user 402 rejects the request or does not respond within an established time interval, the ITV system automatically answers the request by sending a generic pre-recorded video greeting to the caller. Alternatively, a caller-specific video greeting may be sent based on the caller's identity. If the caller so desires, the ITV system may then record a video message including an audio/video signal sent by the caller.

In certain embodiments, a video message is displayed to the user while it is being recorded. For example, the video message may be displayed on the user's television in a Picture-in-Picture (PIP) window. In addition, the user may interrupt the recording of the video message (or the transmission of the video greeting) to immediately communicate with the caller. Of course, in alternative embodiments, recording of the video message may continue while the user communicates with the caller.

In certain embodiments, if the user accepts the request (or later interrupts the recording of a video message to communicate with the caller), the ITV system begins to buffer a television signal being currently displayed. When the video communication is terminated, the ITV system plays back the television program being buffered from the point in time at which the communication commenced.

The ITV system may also include an auto-answer list. In one embodiment, rather than interrupting the user with a notification of every incoming video call, the ITV system automatically answers and records video calls in which the caller is found within the auto-answer list.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. In the following description, numerous specific details are provided, such as examples of programming, software modules, user selections, network transactions, database queries, database structures, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

The following discussion makes particular reference to two-way video communication. However, those skilled in the art recognize that video communication typically includes two-way audio communication. Thus, where video communication and corresponding components are specifically illustrated, audio communication and corresponding components may be implied.

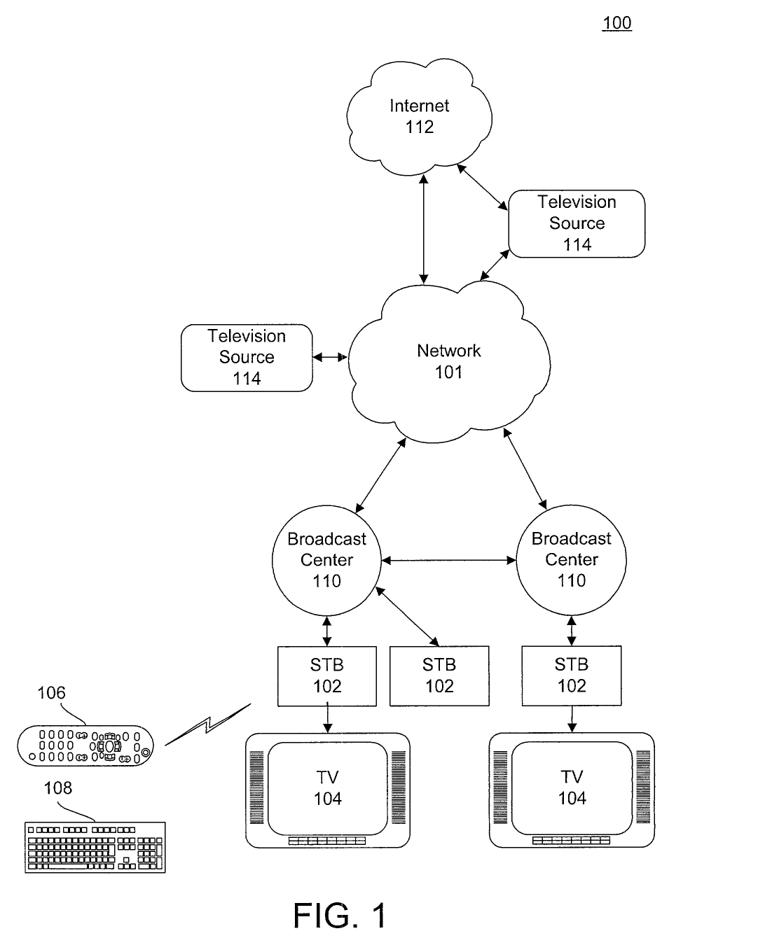

Referring now to FIG. 1, there is shown a communication system 100. In one implementation, the system 100 relies on a broadband network 101 for communication, such as a cable television network or a direct satellite broadcast (DBS) network, although other networks are possible.

The system 100 may include a plurality of set top boxes (STBs) 102 located, for instance, at customer homes or offices. Generally, an STB 102 is a consumer electronics device that serves as a gateway between a customer's television 104 and the network 101. In alternative embodiments, an STB 102 may be embodied more generally as a personal computer (PC), an advanced television 104 with STB functionality, or another type of client terminal.

An STB 102 receives encoded television signals and other information from the network 101 and decodes the same for display on the television 104 or other display device, such as a computer monitor. As its name implies, an STB 102 is typically located on top of, or in close proximity to, the television 104.

Each STB 102 may be distinguished from other network components by a unique identifier, number, code, or address, examples of which include an Internet Protocol (IP) address (e.g., an IPv6 address), a Media Access Control (MAC) address, or the like. Thus, video signals and other information may be transmitted from the network 101 to a specific STB 102 by specifying the corresponding address, after which the network 101 routes the transmission to its destination using conventional techniques.

A remote control 106 is provided, in one configuration, for convenient remote operation of the STB 102 and the television 104. The remote control 106 may use infrared (IR), radio frequency (RF), or other wireless technologies to transmit control signals to the STB 102 and the television 104. Other remote control devices are also contemplated, such as wired or wireless mice (not shown).

Additionally, a keyboard 108 (either wireless or wired) is provided, in one embodiment, to allow a user to rapidly enter text information into the STB 102. Such text information may be used for e-mail, instant messaging (e.g. text-based chat), or the like. In various embodiments, the keyboard 108 may use infrared (IR), radio frequency (RF), or other wireless technologies to transmit keystroke data to the STB 102.

Each STB 102 may be coupled to the network 101 via a broadcast center 110. In the context of a cable television network, a broadcast center 110 may be embodied as a “head-end”, which is generally a centrally-located facility within a community where television programming is received from a local cable TV satellite downlink or other source and packaged together for transmission to customer homes. In one configuration, a head-end also functions as a Central Office (CO) in the telecommunication industry, routing video signals and other data to and from the various STBs 102 serviced thereby.

A broadcast center 110 may also be embodied as a satellite broadcast center within a direct broadcast satellite (DBS) system. A DBS system may utilize a small 18-inch satellite dish, which is an antenna for receiving a satellite broadcast signal. Each STB 102 may be integrated with a digital integrated receiver/decoder (IRD), which separates each channel, and decompresses and translates the digital signal from the satellite dish to be displayed by the television 104.

Programming for a DBS system may be distributed, for example, by multiple high-power satellites in geosynchronous orbit, each with multiple transponders. Compression (e.g., MPEG) may be used to increase the amount of programming that can be transmitted in the available bandwidth.

The broadcast centers 110 may be used to gather programming content, ensure its digital quality, and uplink the signal to the satellites. Programming may be received by the broadcast centers 110 from content providers (CNN, ESPN, HBO, TBS, etc.) via satellite, fiber optic cable and/or special digital tape. Satellite-delivered programming is typically immediately digitized, encrypted and uplinked to the orbiting satellites. The satellites retransmit the signal back down to every earth-station, e.g., every compatible DBS system receiver dish at customers' homes and businesses.

Some broadcast programs may be recorded on digital videotape in the broadcast center 110 to be broadcast later. Before any recorded programs are viewed by customers, technicians may use post-production equipment to view and analyze each tape to ensure audio and video quality. Tapes may then be loaded into a robotic tape handling systems, and playback may be triggered by a computerized signal sent from a broadcast automation system. Back-up videotape playback equipment may ensure uninterrupted transmission at all times.

Regardless of the nature of the network 101, the broadcast centers 110 may be coupled directly to one another or through the network 101. In alternative embodiments, broadcast centers 110 may be connected via a separate network, one particular example of which is the Internet 112. The Internet 112 is a “network of networks” and is well known to those skilled in the art. Communication over the Internet 112 is accomplished using standard protocols, such as TCP/IP (Transmission Control Protocol/Internet Protocol) and the like.

A broadcast center 110 may receive television programming for distribution to the STBs 102 from one or more television programming sources 114 coupled to the network 101. Preferably, television programs are distributed in an encoded format, such as MPEG (Moving Picture Experts Group). Various MPEG standards are known, such as MPEG-2, MPEG-4, MPEG-7, and the like. Thus, the term “MPEG,” as used herein, contemplates all MPEG standards. Moreover, other video encoding/compression standards exist other than MPEG, such as JPEG, JPEG-LS, H.261, and H.263. Accordingly, the invention should not be construed as being limited only to MPEG.

Broadcast centers 110 may be used to enable audio and video communications between STBs 102. Transmission between broadcast centers 110 may occur (i) via a direct peer-to-peer connection between broadcast centers 110, (ii) upstream from a first broadcast center 110 to the network 101 and then downstream to a second broadcast center 110, or (iii) via the Internet 112. For instance, a first STB 102 may send a video transmission upstream to a first broadcast center 110, then to a second broadcast center 110, and finally downstream to a second STB 102.

Of course, the communication system 100 illustrated in FIG. 1 is merely exemplary, and other types of devices and networks may be used within the scope of the invention.

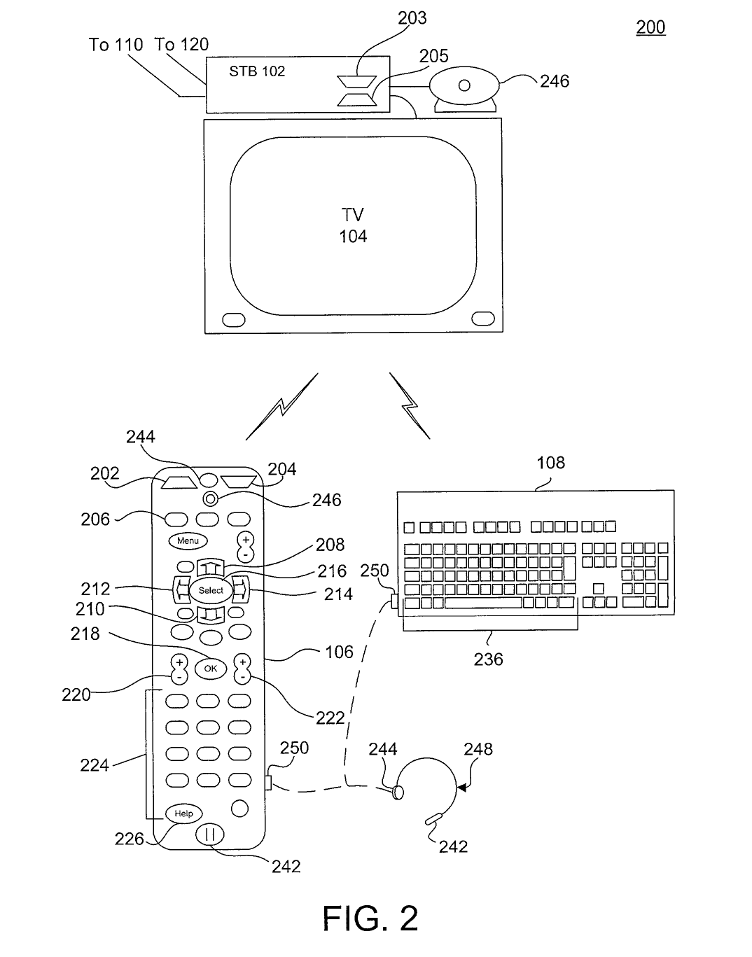

Referring now to FIG. 2, there is shown an interactive television (ITV) system 200 according to an embodiment of the invention. As depicted, the system 200 may include an STB 102, a television 104 (or other display device), a remote control 106, and, in certain configurations, a keyboard 108.

The remote control 106 is provided for convenient remote operation of the STB 102 and the television 104. In one configuration, the remote control 106 includes a wireless transmitter 202 for transmitting control signals (and possibly audio/video data) to a wireless receiver 203 within the STB 102 and/or the television 104. In certain embodiments, the remote control 106 includes a wireless receiver 204 for receiving signals from a wireless transmitter 205 within the STB 102. Operational details regarding the wireless transmitters 202, 205 and wireless receivers 203, 204 are generally well known to those of skill in the art.

The remote control 106 preferably includes a number of buttons or other similar controls. For instance, the remote control 106 may include a power button 206, an up arrow button 208, a down arrow button 210, a left arrow button 212, a right arrow button 214, a “Select” button 216, an “OK” button 218, channel adjustment buttons 220, volume adjustment buttons 222, alphanumeric buttons 224, a “Help” button 226, and the like.

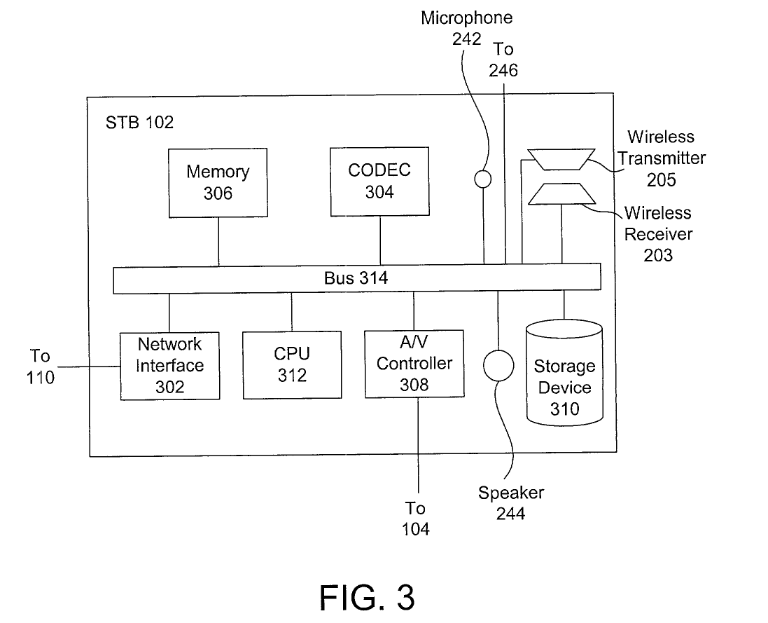

In one embodiment, the remote control 106 includes a microphone 242 for capturing audio signals. The captured audio signals may be transmitted to the STB 102 via the wireless transmitter 202. In addition, the remote control 106 may include a speaker 244 for generating audible output from audio signals received from the STB 102 via the wireless receiver 204. In alternative embodiments, as shown in FIG. 3, the microphone 242 and/or speaker 244 may be integrated with the STB 102.

In certain embodiments, the remote control 106 further includes a video camera 246, such as a CCD (charge-coupled device) digital video camera, for capturing video signals. In one implementation, the video camera 246 is in electrical communication with the wireless transmitter 202 for sending the captured video signals to the STB 102. Like the microphone 242 and speaker 244, the video camera 246 may be integrated with the STB 102, or attached to the STB 102, as in the depicted embodiment.

The various components of the remote control 106 may be positioned in different locations for functionality and ergonomics. For example, as shown in FIG. 2, the speaker 244 may be positioned near the “top” of the remote control 106 (when viewed from the perspective of FIG. 2) and the microphone 242 may be positioned at the “bottom” of the remote control 106. Thus, in one embodiment, a user may conveniently position the speaker 244 near the user's ear and the microphone 242 near the user's mouth in order to operate the remote control 106 in the manner of a telephone.

The optional keyboard 108 facilitates rapid composition of text messages. The keyboard 108 includes a plurality of standard alphanumeric keys 236. In one configuration, the keyboard 108 includes a wireless transmitter (not shown), similar or identical to the wireless transmitter 202 of the remote control 106. The wireless transmitter transmits keystroke data from the keyboard 108 to the STB 102. Additionally, the keyboard 108 may include one or more of the buttons illustrated on the remote control 106.

Alternatively, or in addition, a hands-free headset 248 may be coupled to the remote control 106 or the keyboard 108. The headset 248 may be coupled using a standard headset jack 250. The headset 248 may include a microphone 242 and/or speaker 244. Such a headset 248 may be used to reduce audio interference from the television 104 (improving audio quality) and to provide the convenience of hands-free operation.

Referring now to FIG. 3, there is shown a block diagram of physical components of an STB 102 according to an embodiment of the invention. As noted above, the STB 102 includes a wireless receiver 203 for receiving control signals sent by the wireless transmitter 202 in the remote control 106 and a wireless transmitter 205 for transmitting signals (such as audio/video signals) to the wireless receiver 204 in the remote control 106.

The STB 102 also includes, in one implementation, a network interface 302 for communicating with the network 101 via the broadcast center 110. The interface 302 may include conventional circuitry for receiving, demodulating, and demultiplexing MPEG packets. The interface 302 may also include conventional modem circuitry for sending or receiving data. For example, the interface 302 may conform to the DOCSIS (Data Over Cable Service Interface Specification) or DAVIC (Digital Audio-Visual Council) cable modem standards.

In one configuration, one or more frequency bands (for example, from 5 to 30 MHz) may be reserved for upstream transmission. Digital modulation (for example, quadrature amplitude modulation or vestigial sideband modulation) may be used to send digital signals in the upstream transmission. Of course, upstream transmission may be accomplished differently for different networks 101. Alternative ways to accomplish upstream transmission include using a back channel transmission, which is typically sent via an analog telephone line, ISDN, DSL, or other techniques.

The STB 102 also preferably includes a codec (encoder/decoder) 304, which serves to encode audio/video signals into a network-compatible data stream for transmission over the network 101. The codec 304 also serves to decode a network-compatible data stream received from the network 101. The codec 304 may be implemented in hardware and/or software. Moreover, the codec 304 may use various algorithms, such as MPEG or Voice over IP (VoIP), for encoding and decoding.

The STB 102 further includes a memory device 306, such as a random access memory (RAM), for storing temporary data. Similarly, a read-only memory (ROM) may be provided for storing more permanent data, such as fixed code and configuration information.

In one embodiment, an audio/video (A/V) controller 308 is provided for converting digital audio/video signals into analog signals for playback/display on the television 104. The AV controller 308 may be implemented using one or more physical devices, such as separate graphics and sound controllers. The AN controller 308 may include graphics hardware for performing bit-block transfers (bit-blits) and other graphical operations for displaying a graphical user interface (GUI) on the television 104.

In some implementations, the STB 102 may include a storage device 310, such as a hard disk drive or the like. The storage device 310 may be configured to store encoded incoming and outgoing video signals as well as television broadcasts and retrieve the same at a later time for display. The storage device 310 may be configured, in one embodiment, as a digital video recorder (DVR), enabling scheduled recording of television programs, pausing (buffering) live video, etc. The storage device 310 may also be used in various embodiments to store viewer preferences, parental lock settings, electronic program guide (EPG) data, passwords, e-mail messages, video messages, video greetings, and the like. In one implementation, the storage device 310 also stores an operating system (OS) for the STB 102, such as Windows CE® or Linux®.

As noted above, the STB 102 may include, in certain embodiments, a microphone 242 and a speaker 244 for capturing and reproducing audio signals, respectively. The STB 102 may also include or be coupled to a video camera 246 for capturing video signals. These components may be included in lieu of or in addition to similar components in the remote control 106, keyboard 108, and/or television 104.

A CPU 312 controls the operation of the STB 102, including the other components thereof, which are coupled to the CPU 312 in one embodiment via a bus 314. The CPU 312 may be embodied as a microprocessor, a microcontroller, a digital signal processor (DSP) or other device known in the art. For instance, the CPU 312 may be embodied as an Intel® x86 processor. As noted above, the CPU 312 may perform logical and arithmetic operations based on program code stored within the memory 306 or the storage device 310.

Of course, FIG. 3 illustrates only one possible configuration of an STB 102. Those skilled in the art will recognize that various other architectures and components may be provided within the scope of the invention. In addition, various standard components are not illustrated in order to avoid obscuring aspects of the invention.

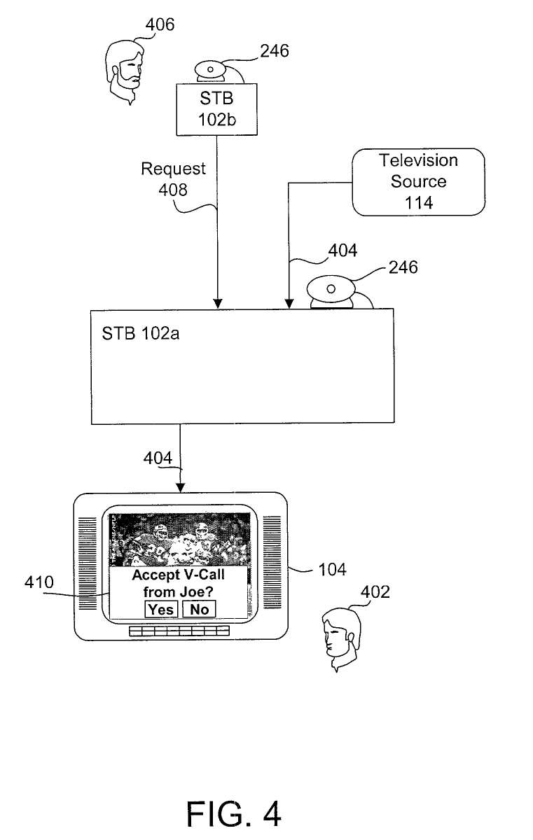

FIGS. 4-8 are high-level dataflow diagrams illustrating various operations and transactions according to embodiments of the invention. Of course, the illustrated embodiment may be modified in various ways without departing from the spirit and scope of the invention.

As shown in FIG. 4, a user 402 may be viewing a television broadcast on a television 104 coupled to a first STB 102a. In one embodiment, the STB 102a decodes a video signal 404 received, for example, from a television source 114.

A user of a second STB 102b, hereinafter referred to as a caller 406, may then attempt to establish two-way video communication with the user 402 of the first STB 102a. Of course, the caller 406 may use other types of video communication devices, such as a personal computer (PC), a personal digital assistant (PDA), a dedicated videophone, or the like.

In one embodiment, the second STB 102b (or other remote device) sends a video communication request 408 to the first STB 102a. As previously noted, the request 408 may be embodied in various forms, depending on the hardware and software being used.

Upon detecting the request 408, the first STB 102a identifies the caller 406 from information contained within the request 408. In one embodiment, the first STB 102a extracts an identifier from the request 408 that uniquely identifies the caller or the caller's STB 102b. The identifier may include, for instance, the caller's name, the caller's personal network address, the network address of the caller's STB 102b, an image of the caller 406, a live video signal depicting the caller 406, or the like.

The STB 102a then notifies the user 402 concerning the request 408 and identifies the caller 406. This may be accomplished, in one embodiment, by displaying a prompt 410 on the television 104. The prompt 410 may include one or more of the identifiers noted above, and may also include a notice for the user 402 to accept or reject the request 408.

In the depicted embodiment, the prompt 410 is embodied as a pop-up window, including, for example, the name of the caller 406, e.g. “Joe.” Preferably, the prompt 410 is sized and positioned to minimize disruption of television viewing and the like. For example, the prompt 410 may be displayed near the top or bottom of the television screen. Moreover, the prompt 410 may be semitransparent, allowing the underlying television signal 404 being displayed to remain substantially visible.

Identification of the caller 406 allows the user 402 to quickly decide whether to answer the video call or to allow the call to be automatically answered and recorded by the STB 102a. For instance, if the user 402 accepts the request 408, a two-way video communication channel is established between the STB 102a and the STB 102b using standard protocols. In one embodiment, the STB 102a launches a videoconferencing client, such as Microsoft NetMeeting® or CuSeeMe®, to establish a communication channel and manage two-way video communication.

If, however, the user 402 rejects the request 408 (or if the request 408 is not accepted within an established time interval), the prompt 410 is removed and the STB 102a automatically answers the call. In one embodiment, the STB 102a sends a pre-recorded video greeting 502 to the caller 406. The video greeting 502 may invite the caller 406 to leave a video message, which may be stored for subsequent viewing by the user 402.

In one configuration, the same video greeting 502 is sent to every caller 406. Alternatively, one or more caller-specific video greetings 502 may be sent depending on the identity of the caller 406.

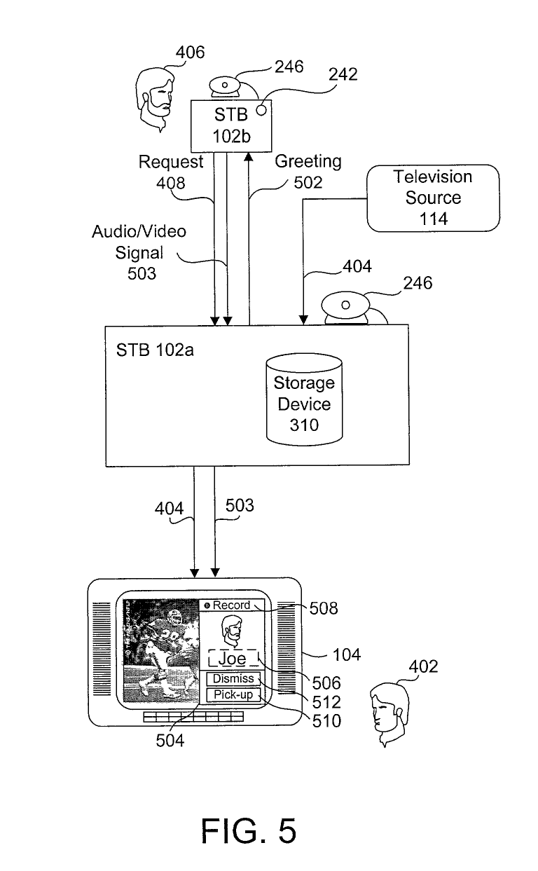

As illustrated in FIG. 5, the request 408 includes or is accompanied by an audio/video signal 503 generated by the microphone 242 and camera 246 associated with the caller's STB 102b. After the video greeting 502 is sent, the STB 102a may begin to record a video message including the audio/video signal 503. In one implementation, the audio/video signal 503 is encoded using a standard method, such as MPEG, and stored within the storage device 310. Recording may continue until the caller 406 terminates the communication.

In one embodiment, the STB 102a displays the audio/video signal 503 while the video message is being recorded. For example, the video portion of the audio/video signal 503 may be displayed in a window 504, such as a Picture-in-Picture (PIP) window, on the television 104. The audio portion of the audio/video signal 503 may or may not be output via the television's speakers.

The window 504 may fill all or a portion of the television screen. In certain configurations, the audio/video signal may be displayed before recording of the video message begins, e.g., when the request 408 is detected or during transmission of the video greeting 502.

The window 504 may also include other identifiers of the caller 406, such as the caller's name 506 or network address. In addition, a status indicator 508 may be provided to indicate, for example, whether the audio/video signal 503 is being currently recorded, whether the greeting 504 is being sent, etc. In one embodiment, once the caller 406 finishes the video message and/or terminates the call, recording of the video message halts and the window 504 is closed.

In one embodiment, although the STB 102a may begin to record a video message, a user may “break in” to establish two-way video communication with the caller 406. For example, the caller 406 may indicate an urgent or interesting reason for his or her call, after which the user 402 may regret rejecting the request 408.

Thus, in one embodiment, the user 402 may establish two-way video communication with the caller 406 at any time by activating a suitable control, such as button on the remote control 106. Alternatively, user may activate a “soft button” displayed on the television 104, such as a “pick-up” button 510.

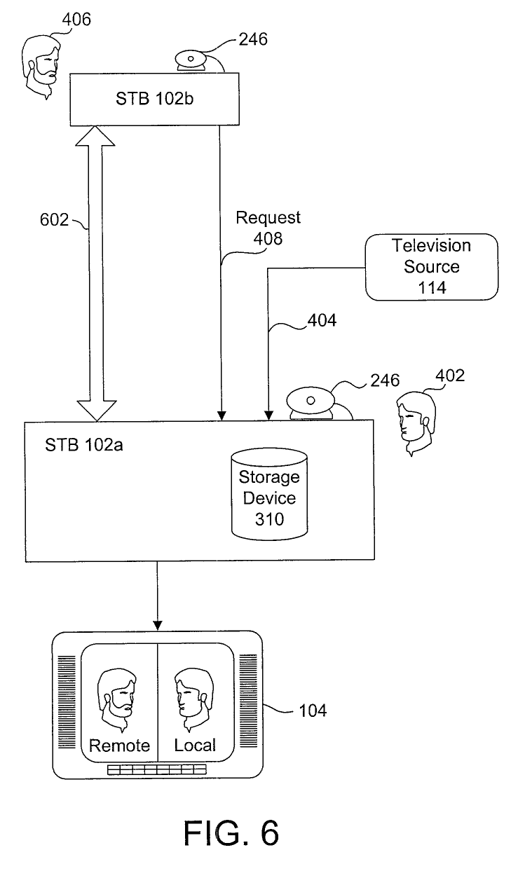

As shown in FIG. 6, activating the pick-up button 510 may allow the user to immediately establish a two-way video communication channel 602 between the STBs 102a, 102b as though the user 402 had initially accepted the request 408. In one implementation, a “dismiss” button 512 closes the window 504, allowing the user to resume watching the television broadcast.

In certain embodiments, the establishment of a two-way video communication channel 602 interrupts the recording of the video message. The recorded video message may be discarded or kept for subsequent review. Alternatively, recording may continue until the channel 602 is terminated by either party. In other embodiments, recording may be resumed during two-way video communication in response to the user 402 activating a suitable control. In various embodiments, the recording may only include audio/video signals received from the caller 406 or may also include audio/video signals sent by the user 402.

In one embodiment, when the communication channel 602 is established, the STB 102a automatically begins to buffer the television signal 404 being displayed. The television signal 404 may be encoded using conventional methods, such as MPEG, after which the encoded television signal 404 is stored within a storage device 310.

Later, when the communication is terminated, the television signal 404 being buffered may be played back from the point in time at which the communication commenced. Buffering may continue during playback, effectively time-shifting the television signal 404 for the period of the communication. As a result, the user 402 may provide complete attention to the caller 406 without missing significant portions of a television broadcast.

In certain configurations, a user 402 may “fast forward” the playback of the buffered television signal 404 to catch up to the live broadcast. For example, the user 402 may press a “fast forward” button on the remote control 106 to move quickly through commercial advertisements. Alternatively, a button may be provided to immediately display the live television signal 404 on the television 104 and terminate the buffering process.

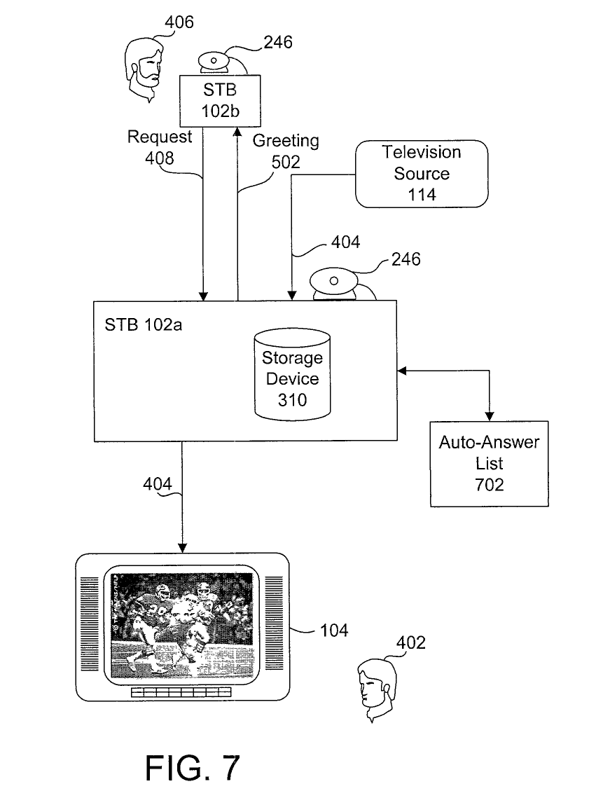

Referring now to FIG. 7, there is shown an alternative embodiment of the invention including an auto-answer list 702. As before, when an incoming request 408 is detected, the caller 406 is identified. If, however, the caller 406 (e.g., the caller's name or network address) is found within the auto-answer list 702, the STB 102a will not notify the user 402 of the request 408. Rather, the STB 102a will automatically answer the request 408 by sending the video greeting 502. The auto-answer list 702 list may be created using various standard data structures, such as arrays, linked lists, database tables, and the like.

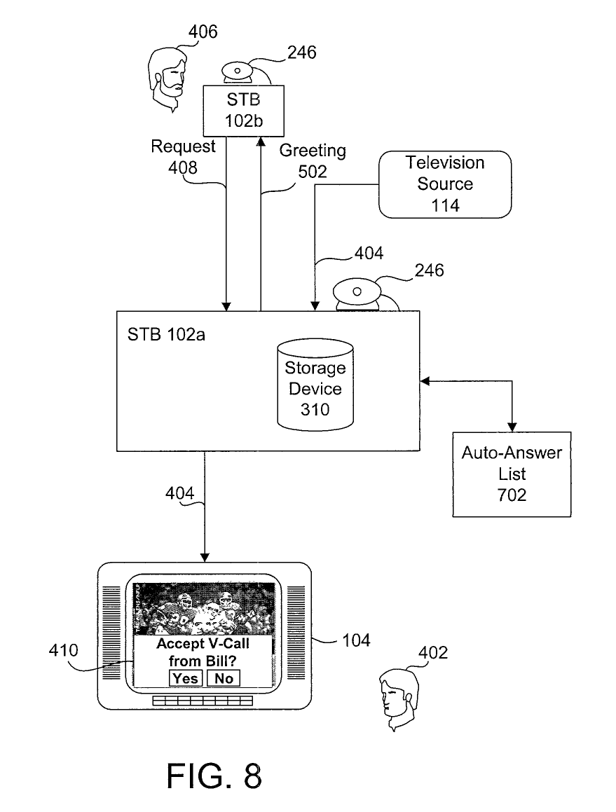

If, however, the caller 406 is not found within the list, the prompt 410 may be displayed, allowing the user 402 to reject or accept the request 408, as shown in FIG. 8. Of course, various other types of lists may be provided, such as a list of callers 406 for which the user 402 will be notified (as opposed to the auto-answer list 702 which lists callers 406 for which the user 402 will not be identified).

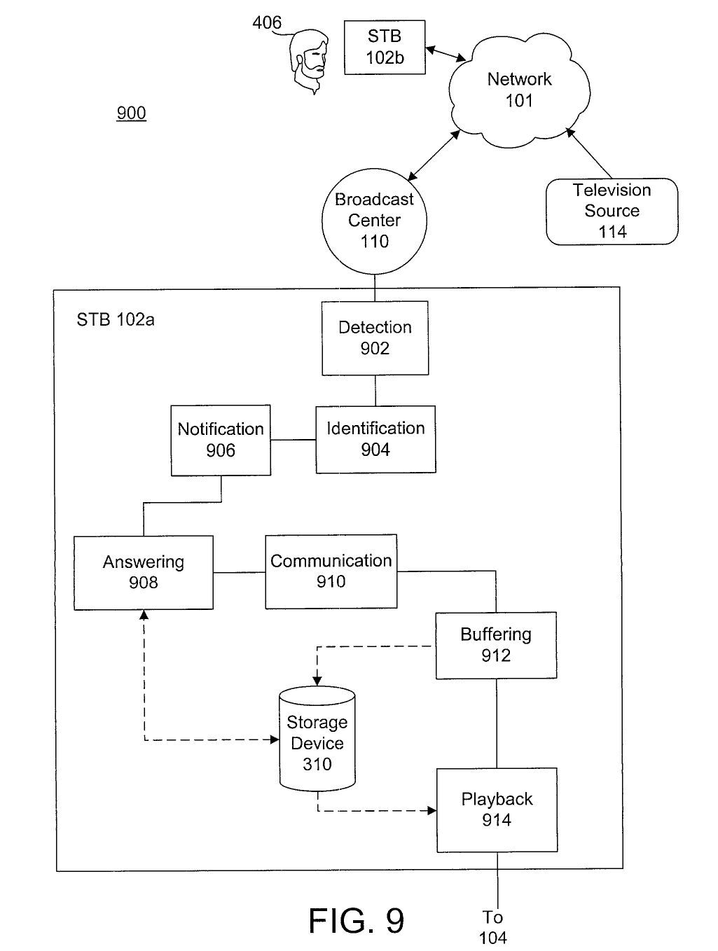

Referring now to FIG. 9, a system 900 for automatically answering and recording video calls is illustrated. The depicted logical components may be implemented using one or more of the physical components shown in FIG. 3. Additionally, or in the alternative, various logical components may be implemented as software modules stored in the memory 306 and/or storage device 310 and executed by the CPU 312. Those skilled in the art will recognize that various illustrated components may be combined together or integrated with standard components in various configurations without departing from the scope or spirit of the invention.

As noted above, a caller's STB 102b may send a video communication request 408 to the user's STB 102a. In one embodiment, the system 900 includes an detection component 902, which detects the request 408, as described above in connection with FIG. 4. The detection component 902 may be implemented as a software module in communication with the network interface 302 of FIG. 3, which monitors incoming packets received from the network 101. Of course, a variety of other implementations are possible.

The system 900 may also include an identification component 904 in communication with the detection component 902. In one implementation, once the detection component 902 detects a request 408, the identification component 904 extracts an identifier from the request 408 to uniquely identify the caller 406 (or the caller's system), as described in connection with FIGS. 4, and 5. The identifier may include, for instance, the caller's name, the caller's personal network address, and/or the network address of the caller's STB 102b.

In the depicted embodiment, the identification component 904 interacts with a notification component 906. As described in connection with FIG. 4, the notification component 906 prompts the user 402 to accept or reject the request 408. For example, the notification component 906 may display a prompt 410, such as a pop-up window, that notifies the user 402 of the incoming request 408, the identity of the caller 406, and the like.

If the user 402 rejects the request 408, or does not accept within an established time interval, an answering component 908 in communication with the notification component 906 automatically begins answering the request 408. As described in FIG. 5, the answering component 908 sends a pre-recorded video greeting 502 to the caller 406. The video greeting 502 may be generic or caller-specific.

Thereafter, the answering component 908 records a video message including an audio/video signal 503 generated by the caller's microphone 242 and camera 246 and transmitted to the user's STB 102b via the network 101. In addition, the answering component 908 may display the video message while it is being recorded.

In certain configurations, the user 402 may be able to establish communication with the caller 406 even after the answering component 908 has begun to record the video message. In response to a user command, a communication component 910 in communication with the answering component 908 establishes a two-way video communication channel 602 between the user 402 and the caller 406, as described in connection with FIG. 6.

In one implementation, once the channel 602 is established, a buffering component 912 in communication with the communication component 910 may begin to buffer the television signal 404 being currently displayed within a storage device 310, as described in connection with FIGS. 5 and 6.

Upon termination of the two-way video communication channel 602, a playback component 914 may begin to play back the buffered television signal 404 from the point in time at which communication commenced. The playback component 914 retrieves the buffered television signal 404 from the storage device 310 and displays the signal 404 on the television 104.

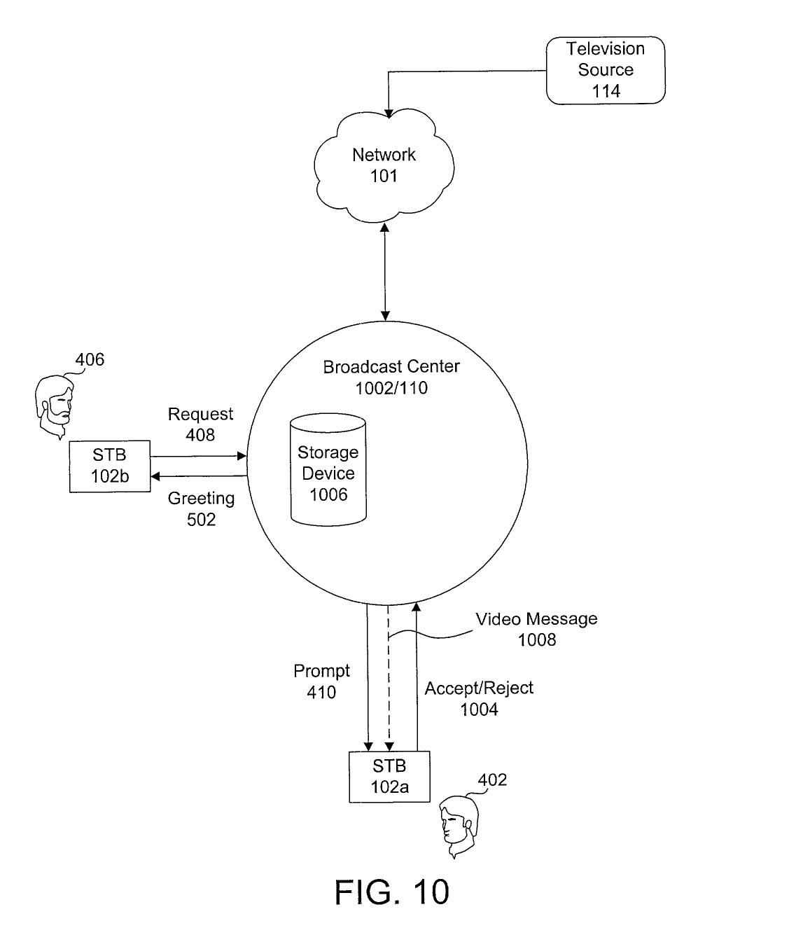

As shown in FIG. 10, one or more of the above-described components may be embodied within a broadcast center 110. For example, a request 408 may be detected, and the caller 406 identified, by the broadcast center 110. Thereafter, the broadcast center 110 may send a prompt 410 to the STB 102a for acceptance or rejection of the request 408. Accept or reject messages 1004 may be sent from the STB 102a to the broadcast center 110. If the user 402 rejects the request 408 (or if the request 408 is not timely accepted), the broadcast center 110 may answer the call by sending a video greeting 502 to the caller's STB 102b.

In such an embodiment, video greetings 502, recorded video messages, auto answer lists 702, and the like, may be stored within a storage device 1006 within or accessible to the broadcast center 110.

In certain embodiments, the broadcast center 110 may transmit stored video messages to the user 402. A video message may be sent, for example, as an e-mail attachment or Internet link. Alternatively, the user may need to access the broadcast center 110 using a client module (not shown), such as RealPlayer®, available from RealNetworks, Inc., in order to retrieve and view stored video messages.

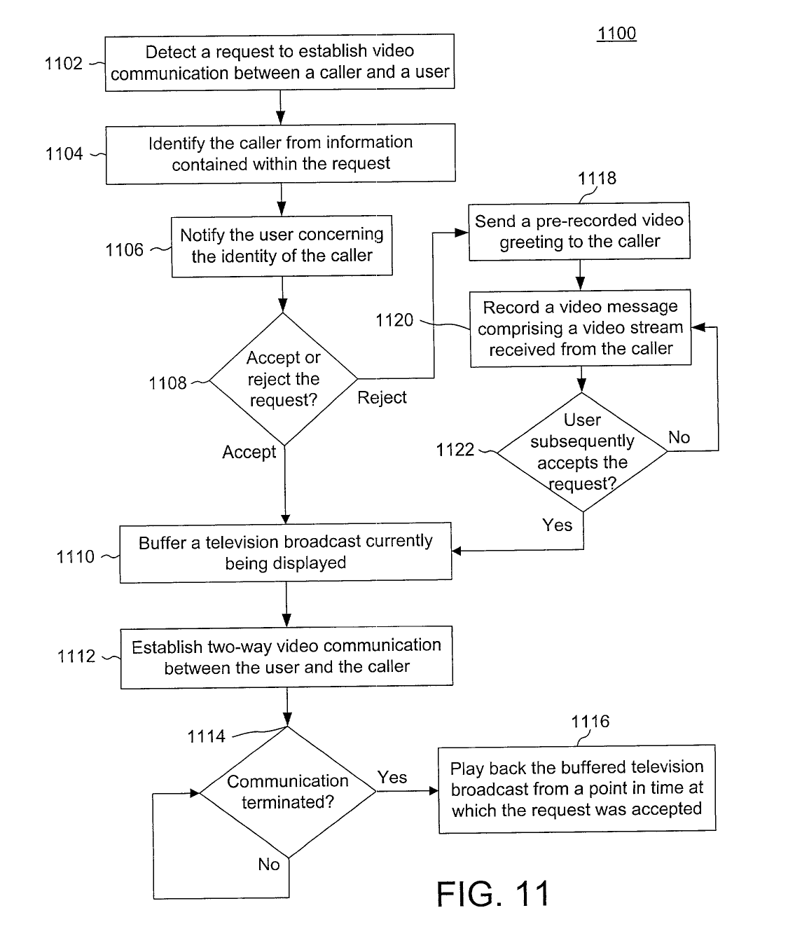

Referring now to FIG. 11, there is shown a flowchart of a method 1100 for automatically answering and recording video calls. The method 1100 begins by detecting 1102 a request 408 from a remote device to establish communication with an interactive television system 200 of a user 402. Next, the caller 406 is identified 1104 using information contained within the request 408. Thereafter, the user 402 is notified 1106 of the identity of the caller 406 and prompted to accept or reject the request 408.

A determination 1108 is then made whether the user accepts or rejects the request 408. If the user accepts, in certain embodiments, a television signal 404 currently being viewed is buffered 1110 to a storage device 310. Thereafter, two-way video communication is established 1112 between the user 402 and the caller 406. Next, a determination 1114 is made whether the communication has been terminated. If so, the television signal 404 being buffered is played back 1116 from a point in time at which the request 408 was accepted 1108. If not, the method returns to step 1114 to await the termination of the communication.

If the user rejects the request 408 in step 1108 or fails to accept the request 408 within an established time interval, the STB 102a sends 1118 a pre-recorded video greeting 502 to the caller 406. Thereafter, the STB 102 records 1120 a video message comprising an audio/video signal 503 received from the caller 406. During recording 1120, in certain configurations, a determination 1122 is made whether the user 402 has subsequently decided to establish communication with the caller 406. If not, the method 1100 continues with recording 1120 until the call is terminated. If, however, the user 402 indicates a desire to establish communication with the caller 406, a television signal 404 being displayed is buffered 11 10, as described above.

Based on the foregoing, the present invention offers a number of advantages not available in conventional approaches. A caller is identified when an incoming call is detected, allowing a user to selectively answer or automatically record calls based on the caller's identity. In addition, a user may interrupt the recording of a video message to answer a call. Moreover, a television program or other broadcast entertainment program is automatically buffered to allow to a user to subsequently view the program in its entirety.

While specific embodiments and applications of the present invention have been illustrated and described, it is to be understood that the invention is not limited to the precise configuration and components disclosed herein. Various modifications, changes, and variations apparent to those skilled in the art may be made in the arrangement, operation, and details of the methods and systems of the present invention disclosed herein without departing from the spirit and scope of the invention.

What is claimed is:

1. A method in an interactive television system for automatically answering and recording video calls, the method comprising:
detecting a request to establish video communication between a caller and a user of the interactive television system;
identifying the caller from information contained within the request;
notifying the user concerning the identity of the caller; and
in response to the user rejecting the request or not accepting the request within an established time interval:
sending a pre-recorded video greeting to the caller; and
recording a video message comprising a video signal received from the caller.

2. The method of claim 1, wherein identifying comprises:
extracting an identifier of the caller from the request.

3. The method of claim 2, wherein the identifier is selected from the group consisting of a name of the caller, a network address of the caller, a network address of an interactive television system of the caller, an image depicting the caller, and a video signal depicting the caller.

4. The method of claim 1, wherein the request comprises a video signal generated by a video camera associated with the caller, and wherein notifying comprises:
displaying the video signal on a display device of the interactive television system.

5. The method of claim 4, wherein displaying comprises:
displaying the video signal in a Picture-in-Picture (PIP) window on the display device.

6. The method of claim 1, further comprising:
while the video message is being recorded, establishing two-way video communication between the user and the caller in response to a user command.

7. The method of claim 6, wherein recording of the video message continues during the two-way video communication.

8. The method of claim 7, wherein the two-way video communication comprises incoming and outgoing video signals, the method further comprising:
storing the incoming and outgoing video signals.

9. The method of claim 6, further comprising:
buffering a television signal being currently displayed by the interactive television system.

10. The method of claim 9, wherein buffering comprises:
encoding the television broadcast; and
storing the encoded television broadcast in a storage device.

11. The method of claim 9, further comprising:
in response to the two-way video communication being terminated, playing back the television signal being buffered from a point in time at which the two-way video communication was established.

12. The method of claim 1, wherein the pre-recorded video greeting is caller-specific.

13. A method in an interactive television system for automatically answering and recording video calls, the method comprising:
detecting a request to establish video communication between a caller and a user of the interactive television system;
identifying the caller from information contained within the request;
determining whether the caller is identified within an auto-answer list; and
in response to the caller being included within the auto-answer list:
automatically sending a pre-recorded video greeting to the caller; and
automatically recording a video message comprising a video signal received from the caller.

14. A method in an interactive television system for automatically answering and recording video calls, the method comprising:
detecting a request to establish video communication between a caller and a user of the interactive television system;
identifying the caller from information contained within the request;
notifying the user concerning the identity of the caller; and
in response to the user rejecting the request or not accepting the request within an established time interval:
sending a pre-recorded video greeting to the caller;
recording a video message comprising a video signal received from the caller;
while the video message is being recorded, establishing two-way video communication between the user and the caller in response to a user command;
buffering a television signal being displayed by the interactive television system; and
in response to the two-way video communication being terminated, playing back the television signal being buffered from a point in time at which the two-way video communication was established.

15. A system for automatically answering and recording video calls, the system comprising:
a detection component configured to detect a request to establish video communication between a caller and a user of the interactive television system;
an identification component configured to identify the caller from information contained within the request;
a notification component configured to notify the user concerning the identity of the caller; and
an answering component configured to send a pre-recorded video greeting to the caller and to record a video message comprising a video signal received from the caller in response to the user rejecting the request or not accepting the request within an established time interval.

16. The system of claim 15, wherein the identification component is further configured to extract an identifier of the caller from the request.

17. The system of claim 16, wherein the identifier is selected from the group consisting of a name of the caller, a network address of the caller, a network address of an interactive television system of the caller, an image depicting the caller, and a video signal depicting the caller.

18. The system of claim 15, wherein the request comprises a video signal generated by a video camera associated with the caller, and wherein the notification component is further configured to display the video signal on a display device of the interactive television system.

19. The system of claim 18, wherein the notification component is further configured to display the video signal in a Picture-in-Picture (PIP) window on the display device.

20. The system of claim 15, further comprising:
a communication component configured to establish two-way video communication between the user and the caller while the video message is being recorded.

21. The system of claim 20, wherein recording of the video message continues during the two-way video communication.

22. The system of claim 21, wherein the two-way video communication comprises incoming and outgoing video signals, and wherein the answering component is further configured to store the incoming and outgoing video signals.

23. The system of claim 20, further comprising:
a buffering component configured to buffer a television signal being currently displayed by the interactive television system.

24. The system of claim 23, wherein buffering component comprises:
an encoder configured to encode the television broadcast; and a storage device configured to store the encoded television broadcast.

25. The system of claim 23, further comprising:
a playback component configured to play back the television signal being buffered from a point in time at which the two-way video communication was established in response to the two-way video communication being terminated,.

26. The system of claim 15, wherein the pre-recorded video greeting is caller-specific.

27. A system for automatically answering and recording video calls, the system comprising:
a detection component configured to detect a request to establish video communication between a caller and a user of the interactive television system;
an identification component configured to identify the caller from information contained within the request;
an answering component configured, in response to the caller being included within an auto-answer list, to automatically send a pre-recorded video greeting to the caller and automatically record a video message comprising a video signal received from the caller.

28. A system for automatically answering and recording video calls, the system comprising:
a detection component configured to detect a request to establish video communication between a caller and a user of the interactive television system;
an identification component configured to identify the caller from information contained within the request;
a notification component configured to notify the user concerning the identity of the caller; and
an answering component configured to send a pre-recorded video greeting to the caller in response to the user rejecting the request or not accepting the request within an established time interval and to record a video message comprising a video signal received from the caller;
a communication component configured, while the video message is being recorded, to establish two-way video communication between the user and the caller;
a buffering component configured to buffer a television signal being displayed by the interactive television system; and
a playback component configured to play back the television signal being buffered from a point in time at which the two-way video communication was established in response to the two-way video communication being terminated.

29. A system for automatically answering and recording video calls, the system comprising:
means for detecting a request to establish video communication between a caller and a user of the interactive television system;
means for identifying the caller from information contained within the request;
means for notifying the user concerning the identity of the caller; and
means for sending a pre-recorded video greeting to the caller and for recording a video message comprising a video signal received from the caller in response to the user rejecting the request or not accepting the request within an established time interval,.

30. A computer program product comprising program code for performing a method for automatically answering and recording video calls, the method comprising:
detecting a request to establish video communication between a caller and a user of the interactive television system;
identifying the caller from information contained within the request;
notifying the user concerning the identity of the caller; and
in response to the user rejecting the request or not accepting the request within an established time interval:
sending a pre-recorded video greeting to the caller; and
recording a video message comprising a video signal received from the caller.
